(19) United States
(12) Patent Application Publication
(10) Pub. No.: US 2007/0166460 A1
(43) Pub. Date: Jul. 19, 2007

(54) Printing dielectric patterns

(75) Inventors: Xiaorong Cai, Lexington, KY (US); Michael John Dixon, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/331,741

(22) Filed: Jan. 13, 2006

(51) Int. Cl. B05D 5/00

(52) U.S. Cl. 427/258

(57) ABSTRACT

Inkjet printing is employed using liquid inks that contain one or more reactive agents that react in situ to form dielectric films on a substrate on which conductive inks or ink receiving inks have previously been printed. At least one of the reactive materials is blocked, so that the reaction does not occur until the material is unblocked by the application of energy during the final film curing process. Illustrative reactive materials are materials with functional groups capable of reacting with active hydrogen, such as isocyanate group, and a second material with functional groups containing active hydrogen, such as hydroxyl. Typical examples are polyols or polyacrylic acids. When additional humectant material is in the ink, a small amount of excess blocked isocyanate is added to the ink to react with additional humectant materials.

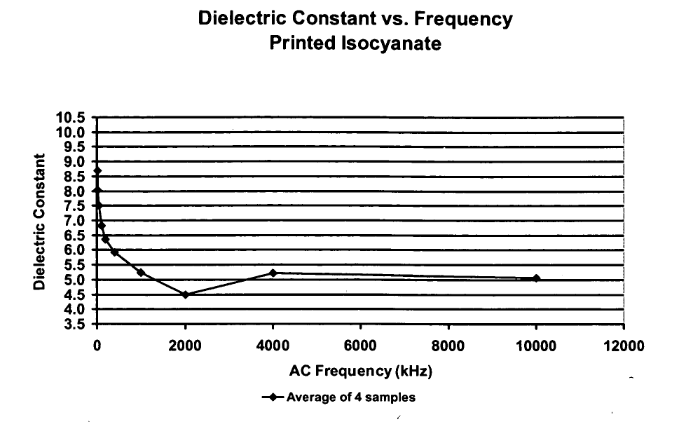

### TECHNICAL FIELD

This invention relates to thermal inkjet printing of a dielectric layers for printed electronics applications.

### BACKGROUND OF THE INVENTION

Inkjet applications for printed electronic patterns is a recent technology. Printed electronics are composed of conducting layers separated by dielectric layers. Many dielectric materials used in the electronic industry are difficult to jet from thermal inkjet printheads. Some dielectric materials can be used in inkjet printheads by preparing emulsions or dispersions, but the dielectric properties will be changed after emulsification.

Using crosslinking materials to form dielectric films is an attractive alternative because the dielectric material is synthesized in situ during a cure step after it is printed onto the substrate. Crosslinked materials also have advantages of better dimensional stability, lower water uptake, and better chemical resistance.

This invention employs blocked reactive crosslinking polymers, such as blocked isocyantes. The general chemistry of chemical reactions by unblocking blocked reactive materials is well understood.

### DISCLOSURE OF THE INVENTION

This invention employs inkjet printing using liquid inks that contain one or more reactive agents that react in situ to form dielectric films on a substrate on which conductive inks or ink receiving inks have previously been printed. At least one of the reactive materials is blocked, so that the reaction does not occur until the material is unblocked by the application of energy during the final film curing process. The pattern printed is on or near an electrical conductor and generally conforms to the shape of the conductor.

The reactive materials are selected from each of two chemical groups. The first group comprises compounds with functional groups capable of reacting with active hydrogen, such as isocyanate group. The second group comprises compounds with functional groups containing active hydrogen, such as hydroxyl, amino, thiol, urethane, or urea groups or functional groups that can be converted into active hydrogen containing functional groups, such as carboxylic acid derivatives (i.e., anhydride groups). Typical examples are polyols or polyacrylic acids.

The material selected from the second group may also act as a humectant. A humectant is a water soluble organic material which is heavier than water and thereby reduces evaporation of water from the ink. This is an advantage because while it is necessary to have humectants in the ink for jetting reliability, the presence of these materials in the final, printed film can adversely affect its physical, chemical, and electrical properties. Most notably, this can lead to higher water uptake than is tolerable in a dielectric material and the presence of non-volatile humectants on the surface of the film. Typically these chemicals must be removed by absorption in a substrate or evaporation during curing. If they can be reacted to form part of the cured film, then they are no longer detrimental to its properties.

The blocked isocyanate and polyol can be formulated as a single ink formulation or two separate ink formulations. The mass ratio of blocked isocyanate and polyol in the formulation is calculated based on the equivalent weight of both materials to yield 1:1 to 3:1 stoichiometric ratios of isocyante:hydroxyl functional groups. When additional humectant material is in the ink, a small amount of excess blocked isocyanate is added to the ink to react with additional humectant materials. This prevents non-volatile humectants from being left on the dielectric film surface after curing.

Inks containing blocked isocyanate and/or polyols are printed to the substrate using inkjet printheads proximate to a conductive material to thereby serve as a dielectric with respect to the conductive material. Heat is applied between layers to partially cure (and dry as necessary) the printed material. This process prevents the surface from becoming too wet and facilitates over-printing of multiple layers. Multiple ink-jetted layers with proper ratio of both materials are formed on the substrate. The printed layers are cured at or above the unblock temperature of the blocked functional groups. Once unblocked, isocyanate groups are free to react with polyol within the multiple printed layers and high quality dielectric films are formed. The dielectric films prepared with the above inks and processes are homogeneous and uniform, with high chemical, water, and abrasion resistances, and low dielectric constants.

### BRIEF DESCRIPTION OF THE DRAWINGS

This invention is illustrated in part by the accompanying drawing which shows the dielectric constant at varying frequencies achieved by final printing in accordance with this invention.

### DESCRIPTION OF THE PREFERRED EMBODIMENTS

Ink Formulations:

Crosslinkers, such as water-reducible, blocked polyisocyanate and crosslinkable materials, such as water reducible or water soluble polyols or acrylic acids may form the dielectric layers. Crosslinking material and crosslikable polymers can be formulated in one ink system or two separated ink systems. The ratios of both crosslinker and crosslikable materials in the formulation were calculated based on the equivalent weights necessary to achieve a 1:1 to 3:1 ratios of crosslinking:crosslinkable functional groups. A small amount of excess crossliker was added to the ink formulation to react with humectant additives containing hydroxyl or active hydrogen groups. This improves the dielectric properties of the film.

Crosslinking reaction will not occur without heating above the de-block temperature of the blocking agent of the blocked isocyanate. This is the property which allows both polyol and isocyanate groups to be present in a single formulation without reacting in the printhead before printing on the substrate. For one-ink system, both blocked polyisocyanate and polyols are added to the same ink.

Humectants, surfactants and other ink additives are required for good jetting properties and stability. For two ink systems, blocked isocyanate and polyol are added into two separate ink formulations with the necessary humectants, surfactants, and additives. Some typical ink formulations are shown in the following examples:

### EXAMPLE 1

Two component Dielectric Ink Formulation:

| Ingredient | Example | percentage |
|---|---|---|
| Blocked isocyanate | BAYHYDUR ® VP LS 2310 | 8% |
| Polyol/Acrylic Acid | JONCRYL ® 678 | 4% |
| Dispersant | Graft Copolymer ′634 | 0.8% |
| Surfactant | SURFYNOL ® 465 | 1% |
| Co-solvent 1 | Propylene glycol | 10% |
| Co-solvent 2 | Poly(ethylene glycol) MW 200 | 5% |
| Balance D.I. Water | | |

### EXAMPLE 2

Two Separated One-component Dielectric Ink Formulation:

### EXAMPLE 2-1

Isocyanate Formulation

| Ingredient | Example | percentage |
|---|---|---|
| Blocked isocyanate | BAYHYDUR ® VP LS 2310 | 10% |
| Dispersant | Graft Copolymer ′634 | 0.8% |
| Surfactant | SURFYNOL ® 465 | 1% |
| Co-solvent 1 | Propylene glycol | 10% |
| Co-solvent 2 | Poly(ethylene glycol) MW 200 | 5% |
| Balance D.I. Water | | |

### EXAMPLE 2-2

Polyol/Acrylic Acid Formulation:

| Ingredient | Example | Percentage |
|---|---|---|
| Polyol/Acrylic Acid | MACRYNAL ® VSM 2521 | 5% |
| Dispersant | Graft Copolymer ′634 | 0.8% |
| Surfactant | SURFYNOL ® 465 | 1% |
| Co-solvent 1 | Propylene glycol | 10% |
| Co-solvent 2 | Poly(ethylene glycol) MW 200 | 5% |
| Balance D.I. Water | | |

BARHYDYRr® VP LS 2310 is a product of Bayer Corp. It is a blocked isocyanate.
JONCRYL 678 is a product of Johnson Polymer. It is a styrenated acrylic polymer.
MACRYNALl® VSM 2521 is a product of UCB. It is a reactive, waterborne acrylic resin containing hydroxyl groups.
SURFYNOL® 465 is a product of Dow Air Products, Corp. It is ethoxylated 2,4,7,9-tetramethyl-5decyn-4,7-diol
Graft Copolymer '634 is a dispersant consistent with the teachings of U.S. Pat. No. 6,652,634 B1 to Akers, Jr. et al., having, for example, a hydrophilic segment of methacrylic acid polymer and a polymer comprising a monomeric hydrophobic head and a polymeric tail, the monomeric hydrophobic heat being (ethylene glycol) 2,4,6-tris(1-phenylethyl)phenyl ether. The dispersant is a minor ingredient with respect to this invention and its specific chemical form may vary widely.
   Material Selection:

The selected materials consistent with this invention include water reducible blocked isocyanates and melamine, water reducible or soluble polyols, acrylic acids and materials with groups containing active hydrogen. Preferred humectants selected for use with this invention are solvents with hydroxyl groups, such as alcohols, diols, and glycols.

Printing Processes:

Evaluation of jetting property evaluation and film formation were completed using mono thermal inkjet printhead(s) of the commercial Lexmark Z815/816 inkjet printers. This printing system was coupled with a flatbed media tray to allow for XY (i.e. lateral and vertical) addressability when printed on nonflexible substrates such as FR4 printed circuit board materials and compact discs. Materials were either printed in normal mode with both materials in one ink formulation in a single a mono printhead or dual-mono mode with each material in a separate ink formulation in two separate mono printheads. In one preferred example embodiment, the printer quality settings are such that each pass through the printer gives coverage of 720,000 dots per square inch from each printhead. In practice this meant making modifications to the printer driver to double the normal quantity of ink when photo mode is selected with a paper type selection of “plain”.

Heat is applied between layers to evaporate unabsorbed liquid from the surface (about 80 to 90° C. at the surface). The heat source could be infrared (IR) heat lamp (˜10 cm from the surface for 1 minute), 80° C. oven for 2 minutes, or heat gun for a few seconds. Layers are repeatedly applied until ˜20-30 micron thickness is achieved. In practice this typically takes 8 to 12 passes through the printer.

Once the last layer is printed, a final cure at or above the unblocking temperature of the isocyanate material is performed. For the blocked isocyanate in the first example formulation above (BAYHYDUR® VP LS 2310) the unblocking temperature is between 80-100° C. Thirty minutes at a temperature of 125° C. has provided good results with this example formulation.

Dielectric Properties Achieved:

Using the Example 1 formulation with the immediately-preceding printing process a graph of dielectric constant versus frequency was obtained as shown in the drawing. The graph is an average of four samples employing the same test procedures. Test structures of the procedures were prepared by first printing a 1-inch-in-diameter, circular conductive electrode on a selected photo media, overprinting with a block of the dielectric material, and then sputtering a 1″ diameter gold electrode on the dielectric material exactly over the location of the bottom electrode to form a parallel plate capacitor. Thicknesses of the laminations were measured using a height gauge (subtracting out the thickness of the photo media) and were approximately 25 μm. Capacitances were measured using a Hewlett-Packard LCR meter and dielectric constants were calculated with the following formula:
C=∈₀∈A/t where
C is capacitance
∈₀ the permittivity of free space (8.854E-12 F/m)
∈ is the dielectric constant or permittivity of the sample
A and t are the area and thickness of the sample respectively.

Films were printed over a larger electrode and bulk resistivities were measured using a Keithley model 8009 resistivity test fixture and a Keithley 6487 picoammeter. Results varied above 10¹² Ω-cm and averaged ˜6×10¹² Ω-cm.

Some key properties of the film formed using this example embodiment are summarized in the table below:

Selected Properties of Isocyanate/Polyol Dielectric film

| | |
|---|---|
| Dielectric Constant @ 1 MHz | 5.2 |
| Bulk Resistivity | 6 × 10¹² Ωcm |
| 24 Hour water uptake, 23 C. | 7.8% |
| Breakdown Voltage | >500 V/mil |

### SUMMARY

Water reducible or water soluble blocked isocyanates and polyols are used as inkjet ink components to form the dielectric films in-situ using inkjet printer and heat curing element.

The blocked isocyanate can be formulated in a single ink formulation with polyols. The polyols also function as the humectant and react with isocyanates during the curing process to improve the film quality. Use of alternative blocked materials and their reactants envisioned. The chemistry of blocked polymers is well established. Accordingly, this invention may be practiced using a wide range of materials.

What is claimed is:

1. The process of forming a dielectric pattern proximate to an electrically conductive material comprising inkjet printing a liquid material having first, blocked functional groups capable of reacting with second functional groups and a liquid material having said second functional groups combined in said pattern, and then applying energy to said combined materials in said pattern to unblock said blocked functional groups to form a solid pattern constituting a dielectric with respect to said proximate electrically conductive material.

2. The process as in claim 1 in which said material said first, blocked functional groups is inkjet printed and said material having said second functional groups are each inkjet printed separately.

3. The process of forming a dielectric pattern proximate to an electrically conductive material comprising inkjet printing a liquid material having blocked functional groups capable of reacting with active hydrogen and a liquid material having functional groups containing active hydrogen, or functional groups that can be converted into active hydrogen containing functional groups combined in said pattern, and then applying energy to said combined materials in said pattern to unblock said block functional groups to form a solid pattern constituting a dielectric with respect to said proximate electrically conductive material.

4. The process as in claim 3 in which said material having blocked functional groups is inkjet printed and said material having active hydrogen are each inkjet printed separately.

5. The process as in claim 3 in which the blocked functional groups of said material having blocked functional groups are isocyanate groups.

6. The process as in claim 4 in which the blocked functional groups of said material having blocked functional groups are isocyanate groups.

7. The process as in claim 3 in which said functional groups of said material having functional groups containing active hydrogen or that can be converted into active hydrogen are hydroxyl, amino, thiol, urethane, or urea groups or anhydrides of carboxylic acids.

8. The process as in claim 4 in which said functional groups of said material having functional groups containing active hydrogen or that can be converted into active hydrogen are hydroxyl, amino, thiol, urethane, or urea groups or anhydrides of carboxylic acids.

9. The process as in claim 5 in which said functional groups of said material having functional groups containing active hydrogen or that can be converted into active hydrogen are hydroxyl, amino, thiol, urethane, or urea groups or anhydrides of carboxylic acids.

10. The process as in claim 6 in which said functional groups of said material having functional groups containing active hydrogen or that can be converted into active hydrogen are hydroxyl, amino, thiol, urethane, or urea groups or anhydrides of carboxylic acids.

11. The process as in claim 3 in which said material having functional groups containing active hydrogen or that can be converted into active hydrogen is a polyol or a polyacrylate.

12. The process as in claim 4 in which said material having functional groups containing active hydrogen or that can be converted into active hydrogen is a polyol or a polyacrylate.

13. The process as in claim 5 in which said material having functional groups containing active hydrogen or that can be converted into active hydrogen is a polyol or a polyacrylate.

14. The process as in claim 6 in which said material having functional groups containing active hydrogen or that can be converted into active hydrogen is a polyol or a polyacrylate.

15. The process as in claim 9 in which at least one of said liquid materials contains a humectant and the stoichiometric ratio of said isocyanate functional groups to said active hydrogen functional groups is greater than 1:1

16. The process as in claim 10 in which at least one of said liquid materials contains a humectant and the stoichiometric ratio of said isocyanate functional groups to said active hydrogen functional groups is greater than 1:1.

17. The process as in claim 13 in which at least one of said liquid materials contains a humectant and the stoichiometric ratio of said isocyanate functional groups to said active hydrogen functional groups is greater than 1:1

18. The process as in claim 14 in which at least one of said liquid materials contains a humectant and the stoichiometric ratio of said isocyanate functional groups to said active hydrogen functional groups is greater than 1:1.
